(19) United States
(12) Patent Application Publication
(10) Pub. No.: US 2022/0266078 A1
(43) Pub. Date: Aug. 25, 2022

(54) FIRE PROTECTION DEVICE WITH WAX COATING

(71) Applicant: Tyco Fire Products LP, Lansdale, PA (US)

(72) Inventors: Pedriant Pena, Berkley, MA (US); Arash Agan, Providence, RI (US); Cassandra Lyn DeNunzio, Cranston, RI (US)

(73) Assignee: Tyco Fire Products LP, Lansdale, PA (US)

(21) Appl. No.: 17/625,525

(22) PCT Filed: Jul. 8, 2020
(86) PCT No.: PCT/IB2020/056433

§ 371 Date: Jan. 7, 2022

Related U.S. Application Data
(60) Provisional application No. 62/873,611, filed on Jul. 12, 2019.

(51) Int. Cl. A62C 35/68; A62C 37/14

(52) U.S. Cl. CPC A62C 35/68; A62C 37/14; A62C 37/04

(57) ABSTRACT

A bursting capsule, which includes a hollow cavity completely enclosed and delimited by a frangible vessel wall with a rupturing liquid disposed therein; an electrically conductive element disposed on an outside surface of the vessel wall; and a wax coating covering the electrically conductive element, is provided. The bursting capsule is typically part of a sprinkler head, which includes first and second electrical contact points in electrical contact with the electrically conductive element disposed on the vessel wall. The wax coating may completely encapsulate the electrically conductive element and the first and second electrical contact points. Fire protection devices and fire protection systems, which include the bursting capsule, are also provided.

### CROSS-REFERENCE TO RELATED APPLICATIONS

The present application claims the benefit of and priority to U.S. Provisional Application No. 62/873,611, filed Jul. 12, 2019, the contents of which are incorporated herein by reference in their entirety.

### BACKGROUND

Automatic sprinkler systems include a network of pressurized pipes that connect a water source to a plurality of sprinkler heads. In most systems, each of the plurality of sprinkler heads is automatically activated by a thermal release element. For example, the sprinkler head can include a bursting capsule positioned between a release valve of the sprinkler head and an external cap of the sprinkler head. The bursting capsule is typically seated against the external cap of the sprinkler head and holds the release valve of the sprinkler head in a closed position. The bursting capsule commonly is filled with a liquid, a gas, or a combination thereof that undergoes thermal expansion when exposed to a thermal trigger. The thermal trigger can be the result of heat from an external source in the environment, e.g., a fire. Thermal expansion of the liquid, gas, or combination thereof breaks the bursting capsule when the temperature meets or exceeds the thermal trigger. The broken bursting capsule falls away from the release valve, causing the release value to open and the sprinkler head to dispense water over the fire.

Since automatic sprinkler systems are deployed in a variety of environmental conditions, the sprinkler heads must be durable and resistant to corrosion and moisture.

### SUMMARY

The present disclosure relates generally to a fire protection system, and more particularly to a fire protection system including thermal release elements, which can be actuated thermally and/or electrically, for permanently-installed fire-fighting equipment, such as automatic sprinkler systems.

One embodiment provides a bursting capsule which can function as a triggering element in a fire protection device, e.g., a sprinkler head in a sprinkler system. The bursting capsule may also be incorporated as a thermal triggering element in the emergency release valve of a gas container or other similar device. The bursting capsule typically includes a hollow cavity completely enclosed and delimited by a vessel wall and a rupturing fluid disposed in the hollow cavity. The bursting capsule also includes an electrically conductive element disposed on an outside surface of the vessel wall that may electrically connect two electrical contact points. The vessel wall is commonly formed from a frangible material, such as glass. In order to enhance the durability and resistance to corrosion and/or moisture of the bursting capsule, the bursting capsule may include a wax coating disposed on at least a portion of the outside surface of the bursting capsule substantially covering the electrically conductive element.

In one embodiment, the fire protection system includes a sprinkler system with a plurality of sprinkler heads, which can be individually automatically activated, e.g., by a release element actuated thermally and/or actuated electrically by application of an electrical current. The release element can include a bursting capsule positioned between a release valve of a sprinkler head and an external cap of the sprinkler head. The bursting capsule is designed to rupture when the release element is exposed to a predetermined condition, e.g., exposure to a thermal trigger and/or to an applied electrical current. The bursting capsule is commonly filled with a rupturing fluid, which may include a rupturing liquid, a gas, or a combination thereof that undergoes rapid thermal expansion when exposed to predetermined thermal conditions (e.g., an increase in the adjacent ambient temperature to a predetermined level) or the application of some other triggering condition that results in breakage of the bursting capsule, typically in a manner that ruptures the bursting capsule. The triggering condition may result from the generation of heat on the surface of the bursting capsule through activation of an electrical current through an electrically conductive element disposed on the surface of the bursting capsule.

In some embodiments, the bursting capsule may be designed to have a relatively fast actuation time through activation by an electrical current passing through an electrically conductive element disposed on the surface of the capsule. As referred to herein, the term “electrical actuation response time” means the length of time required for the bursting capsule to rupture after application of a constant current source of 1.0 amp through an electrically conductive element disposed on the surface of the bursting capsule. For some embodiments, it may be advantageous to have an electrical actuation response time of no more than about 20 seconds, no more than about 10 seconds, no more than about 5 seconds, no more than about 3 seconds, no more than about 2 seconds or no more than about 1 second.

The electrically conductive element disposed on an outside surface of the vessel wall is typically formed from a conductive metal such as silver, copper, gold, aluminum, zinc, nickel, iron and related alloys, e.g., aluminum alloys, brass alloys and various iron alloys. The electrically conductive element may be formed by depositing an electrically conductive coating, suitably formed from the conductive metal, in a continuous path on the vessel wall. In other instances, the electrically conductive element may be pre-fabricated as a separate distinct structure and subsequently attached to the outer surface of the vessel wall, e.g., via an adhesive. In some embodiments, the electrically conductive element may include aluminum or an aluminum alloy. In some embodiments, the continuous path is substantially linear. In some embodiments, the continuous path is substantially spiral-wound along a perimeter of the vessel wall. In other embodiments, the continuous path may have other non-linear configurations connecting opposite ends of the vessel wall.

In addition to a rupturing liquid, a gas bubble may advantageously be disposed in the hollow cavity. This gas bubble may be an air bubble, for example, but may also be a gas that does not promote fire, such as nitrogen and/or carbon dioxide. Such a gas bubble can be used to aid in precisely setting and/or modifying the trigger temperature and/or the predetermined thermal response time of the bursting capsule.

A rupturing liquid is disposed in the hollow cavity, which, together with the optional small gas bubble, substantially fills the volume of the hollow cavity. This liquid is commonly selected such that it causes the bursting capsule to rupture at a predetermined trigger temperature due to thermal expansion, for example when the bursting capsule is exposed to a predetermined trigger temperature in the range from about 50 to 275° C. (about 122 to 527° F.), or in some embodiments, in the range from about 50 to 150° C. (about 122 to 302° F.). When the trigger temperature is reached or exceeded, the rupturing fluid (rupturing liquid and optional gas bubble) in the bursting capsule rapidly expands and the bursting capsule ruptures, typically shattering the capsule.

The rupturing liquid may be selected so that its boiling point occurs at a temperature below the trigger temperature, such that upon reaching or exceeding the trigger temperature but for the presence of the vessel walls, the fluid would take up a much greater volume than the volume of the hollow cavity. This exerts a significant pressure on the vessel walls and upon rupture of the vessel walls, the fluid can be released in a manner such that it rapidly vaporizes and undergoes a substantial expansion of the material as it transitions to the gas phase. In addition to having a desired target boiling point, the rupturing liquid is suitably a liquid with a high coefficient of expansion and/or low compressibility, which can result in a narrow trigger temperature range. Moreover, such substances can facilitate design of a bursting capsule with a fast triggering time.

The rupturing fluid that is filled in the compartment generally results, upon its being heated and the corresponding thermal expansion, in a shattering of the bursting capsule and, therefore, a triggering action of the thermal triggering device. Typically, triggering liquid is filled into the cavity so that a defined gas bubble (typically air) is present. When the capsule is subject to heating—either due to a rise in room temperature or as the result of a current being passed through the electrically conductive element disposed on the vessel wall, the gas bubble absorbs the initial thermal expansion of the triggering fluid until a phase transition of the liquid occurs, resulting in an explosive-type expansion that causes the bursting capsule to shatter.

In some embodiments, the wax coating is configured to provide a substantial degree of protection of the electrically conductive element during exposure to corrosive environments. The bursting capsule is typically designed to retain its function after exposure to common environmental contaminants, such as salt water, moist carbon dioxide-sulfur dioxide air mixtures and moist hydrogen sulfide-air mixtures. In particular, it may be desirable to configure the wax coating to protect the electrically conductive element from corrosion under the conditions set forth for the 10-day corrosion tests specified in the Underwriters Laboratory 199 Standard, which is incorporated by reference herein in relevant part. In order to accomplish this, the wax coating may suitably have an average thickness of at least about 250 μm (0.25 mm), at least about 500 μm (0.5 mm), about 500 μm (0.5 mm) to 1500 μm (1.5 mm) and commonly, about 635 μm (about 0.025 inches) to 1015 μm (about 0.04 inches). In some embodiments, the wax coating may advantageously be configured to have a melting point below the trigger temperature of the capsule. Therefore, where the bursting capsule is designed to be actuated by either exposure to predetermined thermal conditions or by passage of an electrical current through the electrically conductive element disposed on the vessel wall, the wax coating will melt and fall away from the bursting capsule at a temperature below the trigger temperature of the bursting capsule so the wax does not prevent or interfere with the shattering of the bursting capsule at the trigger temperature. In many embodiments, the wax coating is configured to melt at a predetermined melt temperature in the range of about 50 to 275° C. (about 122 to 527° F.), about 50 to 150° C. (about 122 to 302° F.), often about 55 to 125° C. (about 131 to 257° F.).

While the wax coating may advantageously be configured to have a melting point below the trigger temperature of the bulb, the wax coating also needs to be selected to have a melting point such that the wax coating will maintain its structural integrity during prolonged exposure to ambient operating conditions. In some instances, e.g., involving storage structures located in warmer climates, the maximum service temperature (sometimes referred to as the maximum ceiling temperature—see, e.g., UL 199 Table 9.1) may be as high as 225° F. (107° C.) or 300° F. (149° C.) or even higher. As illustrated UL 199 Table 9.1, the maximum service temperature of the bursting capsule may only be about 25° F. (14° C.) lower than the temperature rating (predetermined trigger temperature) of the bursting capsule. In such instances, the melting point of the wax in the coating advantageously may be selected such that the wax coating will maintain its structural integrity during exposure to the maximum service temperature while sufficiently melting on exposure to the predetermined trigger temperature to avoid inhibition of the shattering of the bursting capsule.

In some embodiments, the wax coating can include one or more of a petroleum wax, a mineral wax, an animal wax, and a vegetable wax. Exemplary petroleum waxes include paraffin waxes and synthetic petroleum waxes. Exemplary synthetic petroleum waxes include polyethylene waxes and polypropylene waxes. Exemplary mineral waxes include ceresin wax, montan wax, ozocerite, and peat wax. Exemplary animal waxes include beeswax, Chinese wax, shellac wax, and spermaceti. Exemplary vegetable waxes include bayberry wax, candelilla wax, carnauba wax, ouricury wax, rice bran wax, and soy wax. In some embodiments, the wax coating may advantageously be formed solely from a petroleum wax. Commonly, the petroleum wax is a paraffin wax and/or a synthetic polyethylene wax. In some embodiments, the wax coating may advantageously formed solely from a mineral wax. Commonly, the mineral wax is a ceresin wax. In some embodiments, it may be desirable to use a wax coating which includes two or more of such types of waxes, where the differing wax types may be present in a single layer as a wax blend or may be present as two or more layers, e.g., with each layer being comprised of a distinct wax type or in other instances, present as two or more layers each formed from the same wax.

In some embodiments, the vessel wall may include a frangible material, e.g., vessel wall may be formed from a frangible material, such as where the bursting capsule is a glass bulb.

In some embodiments, the bursting capsule is configured to rupture the vessel wall after the bursting capsule has been at a predetermined trigger temperature for a predetermined response time. As referred to herein, the term “predetermined response time” shall mean the operating time as determined pursuant to UL 199, section 31.2 of a sprinkler head containing the bursting capsule, where the predetermined trigger temperature is the corresponding rated operating temperature (as that term is used in UL 199) of the bursting capsule. The bursting capsule may advantageously be designed to have a predetermined trigger temperature in a range from about 50 to 275° C. (about 122 to 527° F.) and, in some instances, in a range from about 50 to 150° C. (about 122 to 302° F.). The bursting capsule may be configured to have a predetermined response time of no more than about 250 seconds, no more than about 210 seconds, often no more than about 180 seconds, desirably no more than about 140 seconds, desirably no more than about 30 seconds, and, in some instances, no more than about 10 seconds.

In some embodiments, the electrically conductive element has an electrical resistance of no more than about 50 ohms, often no more than about 20 ohms and typically no more than about 10 ohms. For some embodiments, it may be advantageous for the electrically conductive element to have an electrical resistance of no more than about 5 ohms, often no more than about 3.5 ohms and, in some instances, no more than about 2 ohms.

In some embodiments the electrically conductive element has an electrical resistance, which is not increased by more than a factor of five (5), desirably by no more than a factor of two (2) and, in some instances, no more than a factor of 1.3 after exposure to a moist hydrogen sulfide-air mixture pursuant to UL 199 10-day corrosion test conditions.

In some embodiments, the electrically conductive element has an electrical resistance, which is not increased by more than a factor of five (5), desirably by no more than a factor of two (2) and, in some instances, no more than a factor of 1.3 after exposure to a moist carbon dioxide-sulfur dioxide air mixture pursuant to UL 199 10-day corrosion test conditions.

In some embodiments, the electrically conductive element has an electrical resistance, which is not increased by more than a factor of about five (5), desirably by no more than a factor of two (2) and, in some instances, no more than a factor of 1.3 after exposure to a 20% salt spray pursuant to UL 199 10-day corrosion test conditions.

In some embodiments, the bursting capsule has an initial predetermined response time at a predetermined trigger temperature. After exposure to a moist carbon dioxide-sulfur dioxide air mixture pursuant to UL 199 10-day corrosion test conditions, the bursting capsule has a response time at the predetermined trigger temperature which is not greater than about a five (5) multiple, desirably not greater than about a two (2) multiple and, in some instances, not greater than about a 1.3 multiple of the initial predetermined response time.

In some embodiments, the bursting capsule has an initial predetermined response time at a predetermined trigger temperature. After exposure to a moist hydrogen sulfide-air mixture pursuant to UL 199 10-day corrosion test conditions, the bursting capsule has a response time at the predetermined trigger temperature which is not greater than about a five (5) multiple, desirably not greater than about a two (2) multiple and, in some instances, not greater than about a 1.3 multiple of the initial predetermined response time.

In some embodiments, the bursting capsule has an initial electrical actuation response time. After exposure to a moist hydrogen sulfide-air mixture pursuant to UL 199 10-day corrosion test conditions, the bursting capsule has an electrical actuation response time which is not greater than about a five (5) multiple, desirably not greater than about a two (2) multiple and, in some instances, not greater than about a 1.3 multiple of the initial electrical actuation response time.

In some embodiments, the bursting capsule has an initial predetermined response time at a predetermined trigger temperature. After exposure to a 20% salt spray pursuant to UL 199 10-day corrosion test conditions, the bursting capsule has a response time at the predetermined trigger temperature which is not greater than about a five (5) multiple, desirably not greater than about a two (2) multiple and, in some instances, not greater than about a 1.3 multiple of the initial predetermined response time.

In some embodiments, the wax coating can be applied to the bursting capsule by dip or immersion coating. In some embodiments, the bursting capsule is dipped or immersed in melted wax. In some embodiments, the sprinkler head is first coupled to the bursting capsule and dipped or immersed in melted wax. In some embodiments, the wax coating can be applied to the bursting capsule by application of molten wax. In some embodiments, the wax coating may be applied by selectively coating of portions of the bursting capsule and/or the sprinkler head with a brush, roller or other similar application device. In some embodiments, a sufficient amount of current can be applied to the electrically conductive element to heat the electrically conductive element to a temperature above a melting point of the wax but below the trigger temperature of the bursting capsule. Solid wax can then be contacted with at least the heated electrically conductive element and electrical contact points on the sprinkler head. Heat from the electrically conductive element causes a portion of the solid wax to melt, thereby forming the wax coating over at least the electrically conductive element and the electrical contact points on the sprinkler head. In some embodiments, molten wax may be poured over at least a portion of the bursting capsule and the sprinkler head, such that the wax coating covers the electrically conductive element on the bursting capsule and the electrical contact points on the sprinkler head. In other embodiments, the wax coating may cover substantially all of the exposed surface area of the bursting capsule and the electrical contact points on the sprinkler head.

In some embodiments, a fire protection device includes the bursting capsule, e.g., the bursting capsule is part of a sprinkler head or the emergency release valve of a gas container.

In some embodiments, a fire protection system includes at least one sprinkler head that includes the coated bursting capsule.

### BRIEF DESCRIPTION OF THE DRAWINGS

FIG. 1 illustrates a bursting capsule having a wax coating, according to an example embodiment.

FIG. 2 illustrates a bursting capsule having a wax coating, according to another example embodiment.

FIG. 3 illustrates a bursting capsule having a wax coating, according to another example embodiment.

FIG. 4 illustrates a method for manufacturing a sprinkler head according to an example embodiment.

FIG. 5 illustrates a method for manufacturing a sprinkler head according to an example embodiment.

### DETAILED DESCRIPTION

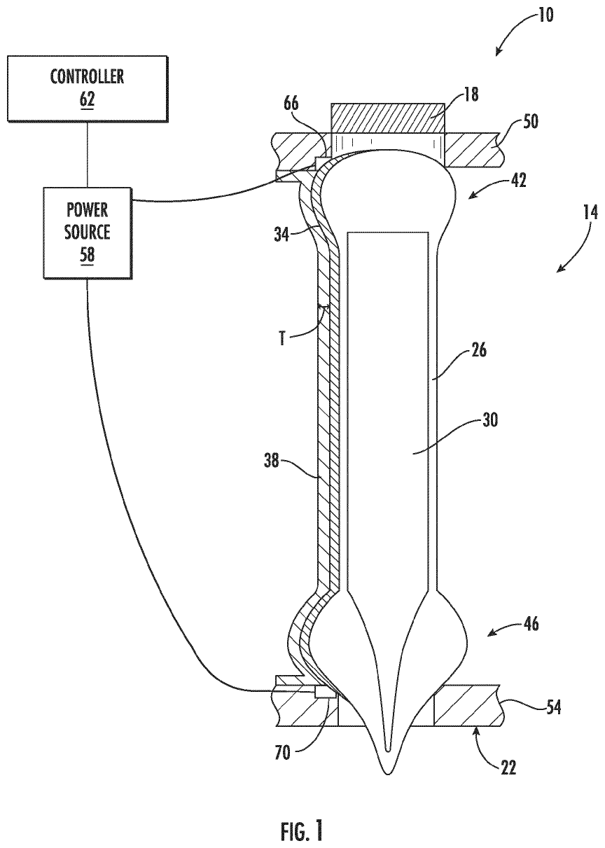

FIG. 1 illustrates a sprinkler head 10 including a bursting capsule 14. The sprinkler head 10 includes a central passageway (not shown), a release valve 18 and a cover 22. The release valve 18 is in fluid communication with a pressurized fluid distribution system. For example, the release valve 18 may be in fluid communication with a network of pressurized pipes that connect a water source to a plurality of sprinkler heads 10.

The bursting capsule 14 includes a wall 26 that completely encloses and delimits a hollow cavity 30, an electrically conductive element 34, and a wax coating 38. In some embodiments, the bursting capsule 14 can be a glass bulb. The bursting capsule 14 may be substantially cylindrical in shape and include a thickened first end 42 and a thickened second end 46. The first end 42 may be received within a first support 50 proximate the release valve 18. The second end 46 may be received within a second support 54 formed in the cover 22 of the sprinkler head 10, such that the bursting capsule 14 holds the release valve 18 in a closed position.

The wall 26 that encloses the hollow cavity 30 can be made of a frangible material such as glass. The hollow cavity 30 typically contains a rupturing liquid (not shown) and may also contain a gas bubble. The rupturing liquid can undergo thermal expansion due to an increase in temperature of the external environment, as can occur during a fire, or due to an applied current. The applied current can be a constant current. The gas bubble can be an air bubble, for example, but may also be a gas that does not promote fire, such as nitrogen and/or carbon dioxide. The gas bubble can be used to precisely set the trigger temperature and/or modify the trigger temperature of the bursting capsule 14. The rupturing liquid can be selected so that the thermal expansion of the rupturing liquid can cause the bursting capsule 14 to rupture after the rupturing liquid has been at a predetermined trigger temperature for a predetermined response time. In some embodiments, the predetermined trigger temperature can be in the range from about 50° C. (122° F.) to about 275° C. (527° F.), often from about 55° C. (131° F.) to about 150° C. (302° F.). Commonly, the predetermined trigger temperature can be in the range from about 55° C. (131° F.) to about 85° C. (185° F.). The predetermined response time is commonly at least about 1 second to avoid instances where rupture of the bursting capsule 14 is accidentally triggered and is generally no more than about 250 seconds. For example, the predetermined response time may desirably be 2 seconds, 3 seconds, 5 seconds, 10 seconds, 20 seconds, 50 seconds, 75 seconds, 150 seconds, 200 seconds, or 210 seconds. In some embodiments, the predetermined response time can be no greater than about 250 seconds. In some embodiments, the predetermined response time can be no more than about 10 seconds and, often no more than about 5 seconds. More particularly, in some embodiments the predetermined response time can be about 2 to 3 seconds. Rupture of the bursting capsule 14 causes the bursting capsule 14 to fall away from the release valve 18 such that the release valve 18 falls into an open position in which water is dispensed from the sprinkler head 10.

In the embodiment illustrated in FIG. 1, the electrically conductive element 34 can be formed by depositing an electrically conductive coating on a portion of the bursting capsule 14 or the electrically conductive element 34 can be adhered to the bursting capsule 14. For example the electrically conductive element 34 may be disposed on an outer wall of the bursting capsule 14. The electrically conductive element 34 overlies at least a portion of the hollow cavity 30. The electrically conductive element 34 can be electrically connected with at least two contact points on the sprinkler head 10, shown schematically as contact point 66 and contact point 70. In other embodiments, the electrically conductive element 34 can extend through the hollow cavity 30 and the ends 42, 46 of the bursting capsule 14. The electrically conductive element 34 can be connected to a power source 58 (such as a power supply or a battery), typically through electrical contact between the electrically conductive element 34 and the contact points 66, 70 on the first and second supports 50, 54. The power source 58 may be in wired or wireless communication with a controller 62, such as a controller of a building management system. In some embodiments, the power source 58 can include a wired power supply, such as a building electric system. In some embodiments, the power source 58 can include one or more batteries. The controller 62 can command the power source 58 to provide an electrical current to the electrically conductive element 34 to cause the bursting capsule 14 to rupture. In some embodiments, the controller 62 can remotely cause the bursting capsule 14 to rupture. In some embodiments, the controller 62 can be proximate and/or integrated with the sprinkler head 10. The electrical current can heat the rupturing liquid in the hollow cavity 30 to the predetermined trigger temperature, causing the bursting capsule 14 to rupture.

The electrically conductive element 34 has an electrical resistance. As referred to herein, the electrical resistance of the electrically conductive element 34 is measured with a Keithley DMM7510 digital multimeter using a 4-wire resistance measurement technique. In some embodiments, the electrical resistance of the electrically conductive element 34 can range between about 1 ohm (Ω) and about 50Ω. In some embodiments, the electrical resistance of the electrically conductive element 34 can be no more than about 20Ω, no more than about 10Ω, no more than about 5Ω, no more than about 3.5Ω, or no more than about 2Ω, or no more than about 1Ω. In some embodiments, the electrical resistance can range between about 3Ω to about 10Ω. In some embodiments, the electrical resistance can range between about 1.5Ω to about 2Ω. In embodiments in which the rupturing liquid in the hollow cavity 30 is to be heated by the electrically conductive element 34, the electrical actuation response time can be a function of the resistance of the electrically conductive element 34. In some embodiments, the electrically conductive element 34 is suitably formed in a continuous path on the vessel wall from a conductive metal, such as silver, copper, gold, aluminum, zinc, nickel, iron and related alloys, e.g., brass alloys, aluminum alloys or various iron alloys. Commonly, the electrically conductive element 34 may include aluminum or an aluminum alloy.

Where the bursting capsule 14 is designed to be actuated by passage of an electrical current through the electrically conductive element 34 disposed on the vessel wall, it is commonly desirable for the bursting capsule 14 to have an electrical actuation response time of no more than about 10 seconds as determined using a constant current source of 1.0 amp. For some embodiments, it may be advantageous to have a faster electrical actuation response time, such as an electrical actuation response time of no more than about 5 seconds, no more than about 3 seconds, no more than about 2 seconds or no more than about 1 second.

The wax coating 38 is formed on an exterior surface of the wall 26 and the electrically conductive element 34. In the illustrated embodiment, the wax coating 38 covers a central portion of the bursting capsule 14 but does not cover the ends 42, 46. In other embodiments, the wax coating 38 can cover more or less of the exterior surface of the wall 26 so long as the wax coating 38 substantially covers the electrically conductive element 34, forming a contiguous coating on the electrically conductive element 34 and the contact points 66, 70. In some embodiments, the wax coating 38 can overlie only the electrically conductive element 34 and optionally a portion of the exterior surface of the wall 26 that is proximate the electrically conductive element 34. In some embodiments, the wax coating covers substantially the entire outside surface of the vessel wall. In some embodiments, the wax coating 38 completely encapsulates the electrically conductive element 34 and the contact points 66, 70. As used herein, the phrase “completely encapsulates” means that the wax coating 38 forms a fluid-tight seal around the electrically conductive element 34 and the contact points 66, 70 such that the electrically conductive element 34 and the contact points are not exposed to the air conditions of the area surrounding and adjacent to the sprinkler head 10 and the bursting capsule 14.

In other embodiments, the wax coating 38 can overlie the electrically conductive element 34, the contact points 66, 70, and substantially an entire exterior surface of the bursting capsule 14 and the sprinkler head 10. In such an embodiment, the phrase “exterior surface” is used to refer to portions of the sprinkler head 10 and the bursting capsule 14 that are exposed to the air conditions of the area being treated by the sprinkler head 10 and the bursting capsule 14 when the sprinkler head 10 and the bursting capsule 14 are engaged with a sprinkler system. Commonly, the wax coating 38 completely encapsulates the exterior surfaces of the sprinkler head 10 and the bursting capsule 14. As illustrated in FIG. 1, the wax coating 38 can have a thickness T of between about 500 μm (0.5 mm) through about 1500 μm (1.5 mm). In some embodiments, the wax coating 38 can have a thickness T of between about 635 μm and about 1016 μm. The wax coating may be configured to melt at a predetermined melt temperature in the range of about 50 to 150° C. (about 122 to 302° F.) and, often, about 50 to 125° C. (about 122 to 257° F.). The wax coating 38 may have a predetermined melting temperature from about 50° C. (122° F.) to about 125° C. (257° F.). More commonly, the predetermined melting temperature can be from about 50° C. (122° F.) to about 100° C. (212° F.). More preferably, the predetermined melting temperature can be from about 50° C. (122° F.) to about 85° C. (185° F.) or from about 55° C. (131° F.) to about 85° C. (185° F.). The wax coating 38 has a melting point below the trigger temperature of the bursting capsule 14. Commonly, the melting point of the wax coating 38 is at least 2.5° C. (5° F.) below than the trigger temperature of the bursting capsule 14. Often, the melting point of the wax coating 38 is at least 5° C. (9° F.) below the trigger temperature of the bursting capsule 14. In some embodiments, the bursting capsule may have a trigger temperature in a range from about 55° C. (131° F.) to about 275° C. (527° F.). Therefore, at temperatures lower than the trigger temperature, the wax coating 38 is configured to melt and flow away from the bursting capsule 14 so that the heat from environment can heat the rupturing liquid received in the hollow cavity 30. Furthermore, in embodiments in which a current is applied to the electrically conductive element 34 to heat the bursting capsule 14 to the trigger temperature, the wax coating 38 is configured to melt and flow away from the bursting capsule before the bursting capsule 14 reaches the trigger temperature. Therefore, the wax coating 38 does not inhibit the bursting capsule 14 from falling away from the release valve 18 of the sprinkler head 10 after the bursting capsule 14 breaks.

In some embodiments, the wax coating 38 comprises one or more of a petroleum wax, a mineral wax, an animal wax, and a vegetable wax. Exemplary petroleum waxes include paraffin wax and polyethylene wax. Exemplary polyethylene waxes include synthetic petroleum waxes. Exemplary mineral waxes include ceresin wax, montan wax, ozocerite, and peat wax. Exemplary animal waxes include beeswax, Chinese wax, shellac wax, and spermaceti. Exemplary vegetable waxes include bayberry wax, candelilla wax, carnauba wax, ouricury wax, rice bran wax, and soy wax. In some embodiments, the wax coating may advantageously be formed solely from a petroleum wax. Commonly, the petroleum wax is a paraffin wax. In some embodiments, the wax coating 38 may advantageously formed solely from a mineral wax. Commonly, the mineral wax is a ceresin wax. In some embodiments, it may be desirable to use a wax coating which includes two or more of such types of waxes, where the differing wax types may be present in a single layer as a wax blend or may be present as two or more layers, e.g., with each layer being comprised of a distinct wax type. The wax coating 38 is not brittle. The wax coating 38 typically does not show evidence of deterioration, such as cracking, flaking, or flowing after ninety (90) days of exposure to ambient temperatures of at least about 50° C. (122° F.) and no more than about 150° C. (302° F.) or about 11° C. (20° F.) below the trigger temperature (whichever is lower) of the bursting capsule 14.

In some embodiments, the wax coating 38 can be applied to the bursting capsule 14 by dip or immersion coating. In some embodiments, the sprinkler head 10 is coupled to the bursting capsule 14 and dipped or immersed in melted wax. In some embodiments, the bursting capsule 14 is dipped or immersed in melted wax. In some embodiments, the wax coating 38 can be applied to the bursting capsule 14 and/or the sprinkler head 10 by application of molten wax as an aerosol formulation. In some embodiments, the wax coating 38 may be applied by selectively coating of portions of the bursting capsule 14 and/or the sprinkler head 10 with a brush, roller or other similar application device. In some embodiments, an amount of current can be applied to the electrically conductive element 34 of the bursting capsule 14 to heat the electrically conductive element 34 to a temperature above a melting point of the wax and below the trigger temperature of the bursting capsule 14. Solid wax can be rubbed against at least the electrically conductive element 34 and electrical contact points 66, 70 on the sprinkler head 10. Heat from the electrically conductive element 34 causes a portion of the solid wax to melt, thereby applying the wax coating 38 over at least the electrically conductive element 34 and the electrical contact points 66, 70 on the sprinkler head 10. In some embodiments, molten wax can be poured over the bursting capsule 14 and the electrical contact points 66, 70 on the sprinkler head 10. In some embodiments, the wax coating 38 covers the electrically conductive element 34 of the bursting capsule 14 and the electrical contact points 66, 70 on the sprinkler head 10. In other embodiments, the wax coating 38 covers substantially all of the exposed surface area of the bursting capsule 14 and the electrical contact points 66, 70 on the sprinkler head 10.

In some embodiments, the trigger temperature of the bursting capsule 14 is about 57° C. (135° F.) and the wax coating 38 is a petroleum wax that has a melting point of about 50° C. (122° F.) to about 54° C. (129° F.). In some embodiments, the trigger temperature of the bursting capsule 14 is about 68° C. (155° F.) and the wax coating 38 is a petroleum wax that has a melting point of about 54° C. (130° F.) to about 58° C. (137° F.). In some embodiments, the trigger temperature of the bursting capsule 14 is about 79° C. (175° F.) and the wax coating 38 is a petroleum wax that has a melting point of about 71° C. (160° F.) to about 75° C. (167° F.). In some embodiments, the trigger temperature of the bursting capsule 14 is about 93° C. (200° F.) or about 141° C. (286° F.) and the wax coating 38 is a petroleum wax that has a melting point of about 77° C. (170° F.) to about 81° C. (177° F.). In some embodiments, the trigger temperature of the bursting capsule 14 is about 74° C. (165° F.) and the wax coating 38 is a mineral wax that has a melting point of about 61° C. (142° F.). In some embodiments, the trigger temperature of the bursting capsule 14 is about 100° C. (212° F.) or about 141° C. (286° F.) and the wax coating 38 is a mineral wax that has a melting point of about 79° C. (175° F.) and a congealing point of about 73° C. (164° F.). In some embodiments, the trigger temperature of the bursting capsule 14 is about 57° C. (135° F.) to about 141° C. (286° F.) and the wax coating has a melting point of about 50° C. (122° F.) to about 81° C. (177° F.).

In some embodiments, the bursting capsule 14 includes the rupturing liquid and the gas bubble disposed in the hollow cavity 30. The frangible material of the bursting capsule 14 is glass. The electrically conductive element 34 has an electrical resistance of no more than about 10 ohms. The bursting capsule 14 has a predetermined trigger temperature in a range from 50 to 275° C. and an electrical actuation response time of no more than about 10 seconds.

In some embodiments, a fire protection device includes the sprinkler head 10. The sprinkler head 10 includes the first and second electrical contact points 66, 70 in electrical contact with the electrically conductive element 34 disposed on an outside surface of the vessel wall 26 of the bursting capsule 14. The contiguous wax coating 38 completely encapsulates the electrically conductive element 34 and the first and second electrical contact points 66, 70. The bursting capsule 14 includes the hollow cavity 30 completely enclosed and delimited by the vessel wall 26. A rupturing liquid is disposed in the hollow cavity 30. The vessel wall 26 includes a frangible material. The frangible material may be glass.

In some embodiments, a fire protection device includes the sprinkler head 10. The sprinkler head 10 includes the first and second electrical contact points 66, 70 in electrical contact with an electrically conductive element 34 disposed on an outside surface of the vessel wall 26 of the bursting capsule 14. The contiguous wax coating 38 completely encapsulates the electrically conductive element 34 and the first and second electrical contact points 66, 70. The bursting capsule 14 includes a hollow cavity 30 completely enclosed and delimited by the vessel wall 26 and a rupturing liquid having a predetermined trigger temperature disposed in the hollow cavity 30. The vessel wall 26 includes a frangible material. The frangible material may be glass.

In some embodiments, a fire protection sprinkler includes a body, such as the sprinkler head 10 and a closure assembly, such as the release valve 18 and the first support 50. The body defines an internal passageway with an outlet end. A heat-responsive trigger, such as the bursting capsule 14, is mounted to releasably secure a closure element, such as the release valve 18, at the outlet end. The heat-responsive trigger includes an electrically conductive element 34 configured to actuate the heat-responsive trigger. The closure assembly includes the closure element mounted in a manner to secure the outlet end of the internal passageway against a flow of fire-fighting fluid in a non-fire condition and to release a flow of the fire-fighting fluid from the outlet end of the internal passageway in response to passage of a current through the electrically conductive element 34. The heat-responsive trigger includes the contiguous wax coating 38 covering the electrically conductive element 34 and first and second electrical contact points 66, 70, which are in electrical contact with and configured to deliver an electric current through the electrically conductive element 34.

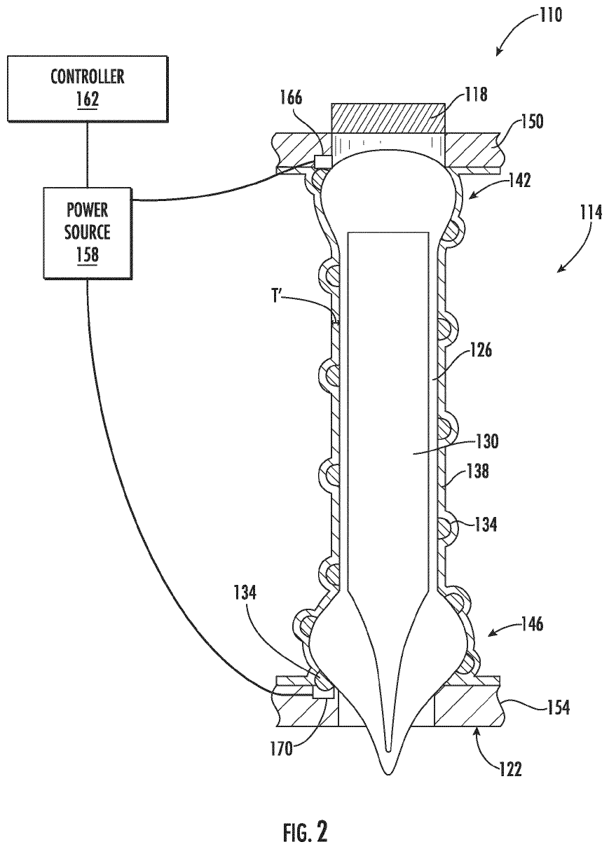

FIG. 2 illustrates a sprinkler head 110 including a bursting capsule 114. The sprinkler head 110 and the bursting capsule 114 are substantially similar to the sprinkler head 10 and the bursting capsule 14 described with respect to FIG. 1. Like parts between the sprinkler head 10 and the bursting capsule 14 and the sprinkler head 110 and the bursting capsule 114 have similar numbering, with the numeral “1” appended between the corresponding parts on the sprinkler head 110 and the bursting capsule 114. The sprinkler head 110 and the bursting capsule 114 is described herein as it differs from the sprinkler head 10 and the bursting capsule 14.

As illustrated in FIG. 2, the electrically conductive element 134 is wound over a surface of the bursting capsule 114. In some embodiments, the electrically conductive element 134 is suitably formed in a continuous path on the vessel wall 126 from a conductive metal. The conductive metal is described above with respect to the electrically conductive element 34. In some embodiments, the conductive path on the vessel wall 126 is substantially helical. In some embodiments, the conductive path on the vessel wall 126 includes substantially parallel rows of the conductive material connected by curved portions of conductive metal. The electrically conductive element 134 has a thickness T′ that is substantially similar to the thickness T described above with respect to the wax coating 38.

The wax coating 138 is formed on an exterior surface of the wall 126, the electrically conductive element 134, and the contact points 166, 170. More particularly, the wax coating 138 forms a contiguous coating over the electrically conductive element 134 and the contact points 166, 170. Commonly, as illustrated in FIG. 2, the wax coating 138 forms a contiguous coating over the electrically conductive element 124, the contact points 166, 170, the exposed surfaces of the bursting capsule 114, and the exposed surfaces of the sprinkler head 110.

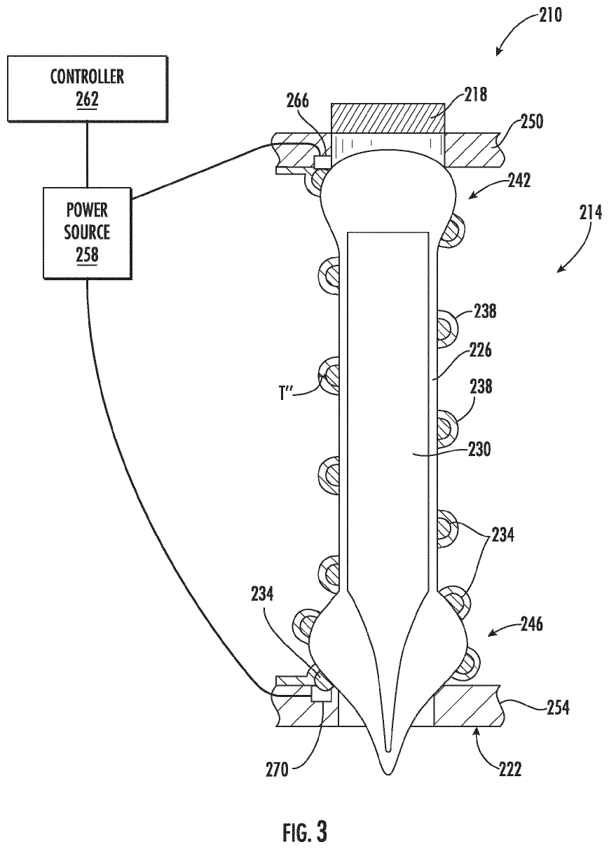

FIG. 3 illustrates a sprinkler head 210 including a bursting capsule 214. The sprinkler head 210 and the bursting capsule 214 are substantially similar to the sprinkler head 10 and the bursting capsule 14 described with respect to FIG. 1. Like parts between the sprinkler head 10 and the bursting capsule 14 and the sprinkler head 210 and the bursting capsule 214 have similar numbering, with the numeral “2” appended between the corresponding parts on the sprinkler head 210 and the bursting capsule 214. The sprinkler head 210 and the bursting capsule 214 is described herein as it differs from the sprinkler head 10 and the bursting capsule 14.

As illustrated in FIG. 3, the electrically conductive element 234 may be wound over a surface of the bursting capsule 214. In some embodiments, the electrically conductive element 234 is suitably formed in a continuous path on the vessel wall 226 from a conductive metal. The conductive metal is described above with respect to the electrically conductive element 34. In some embodiments, the conductive path on the vessel wall 226 is substantially helical. In some embodiments, the conductive path on the vessel wall 226 includes substantially parallel rows of the conductive material connected by curved portions of conductive metal. The wax coating 234 has a thickness T″ that is substantially similar to the thickness T described above with respect to the wax coating 38.

The wax coating 238 is formed on an exterior surface of the wall 226, the electrically conductive element 234, and the connecting portions 266, 270. More particularly, the wax coating 238 forms a contiguous coating over the electrically conductive element 234 and the connecting portions 266, 270. Commonly, as illustrated in FIG. 3, the wax coating 238 forms a contiguous coating over the electrically conductive element 234, the connecting portions 226, 270, and portions of exposed surfaces of the sprinkler head 210 that are adjacent the connecting portions 226, 270. The wax coating 238 does not extend over the exposed surfaces of the bursting capsule 114, and the exposed surfaces of the sprinkler head 110 that are not adjacent to and/or coupled to the electrically conductive element 234 or the connecting portions 226, 270.

Illustrative Method of Manufacturing Sprinkler Head with Wax Coating

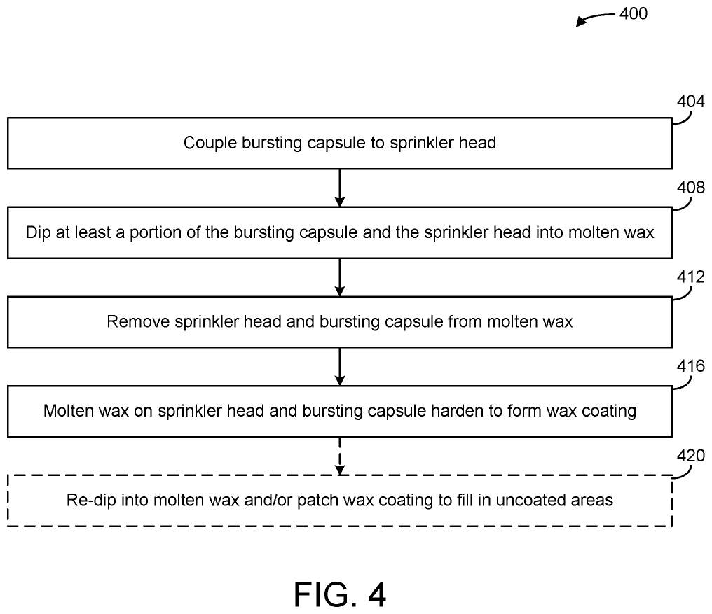

FIG. 4 illustrates a method 400 for manufacturing a sprinkler head 10 according to some embodiments. In step 404, the bursting capsule 14 is coupled to the sprinkler head 10 such that the electrically conductive element 34 of the bursting capsule 14 forms an electrical connection with the contact points 66, 70 in the sprinkler head 10.

In step 408, at least a portion of the bursting capsule 14 and the sprinkler head 10 are dipped into a vat of molten wax such that at least the electrically conductive element 34 and the contact points 66, 70 are immersed in the molten wax. In some embodiments, the sprinkler head 10 and bursting capsule 14 are spun while immersed in the molten wax. In some embodiments, the sprinkler head 10 and the bursting capsule 14 may be spun about 2-3 times for a total of about 5 seconds. Commonly, the melting point of the wax coating 38 is at least about 2.5° C. (5° F.) below than the trigger temperature of the bursting capsule 14. More preferably, the melting point of the wax coating 38 is at least about 5° C. (9° F.) below the trigger temperature of the bursting capsule 14. In some embodiments, a temperature of the molten wax can range from about 63° C. (145° F.) to about 102° C. (215° F.).

In step 412, the sprinkler head 10 and bursting capsule 14 are removed from the molten wax. In step 416, the molten wax on the sprinkler head 10 and the bursting capsule 14 hardens, forming the wax coating 38. The wax coating 38 can have a thickness T of between about 500 μm (0.5 mm) through about 1500 μm (1.5 mm). In some embodiments, the wax coating 38 can have a thickness T of between about 635 μm and about 1016 μm. The wax coating 38 substantially covers the electrically conductive element 34, forming a contiguous coating on the electrically conductive element 34 and the contact points 66, 70. In some embodiments, the wax coating 38 can overlie only the electrically conductive element 34 and optionally a portion of the exterior surface of the wall 26 that is proximate the electrically conductive element 34. In some embodiments, the wax coating 38 completely encapsulates the electrically conductive element 34 and the contact points 66, 70.

In optional step 420, the sprinkler head 10 and the bursting capsule 14 may be re-dipped and/or the wax coating 38 may be patched to fill in any uncoated areas.

In some embodiments, the bursting capsule 14 may be immersed in the molten wax before the bursting capsule 14 is coupled to the sprinkler head 10 in a manner similar to the method 400. In such an embodiment, step 404 is not completed and steps 408-420 are performed for the bursting capsule 14. After the wax coating 38 has hardened (e.g., after steps 416 or 420), the bursting capsule 14 is coupled to the sprinkler head 10. In some embodiments, the sprinkler head 10 includes at least one protrusion proximate each of the electrical contact points 66, 70 configured to pierce through the wax coating 38 and form an electrical connection between the electrically conductive element 34 and the contact points 66, 70. In other embodiments, the wax coating 38 proximate the electrical contact points 66, 70 and the portion of the electrically conductive element 34 adjacent the electrical contact points 66, 70 may scrape off during installation of the bursting capsule 14, thereby allowing electrical contact between the electrical contact points 66, 70 and the bursting capsule 14. In embodiments in which the bursting capsule 14 is coated before being coupled to the sprinkler head 10, a portion of the wax coating 38 near the electrical connections between the electrically conductive element 34 and the contact points 66, 70 may be melted and allowed to re-harden to form a continuous, fluid-tight coating over the electrically conductive element 34 and the contact points 66, 70.

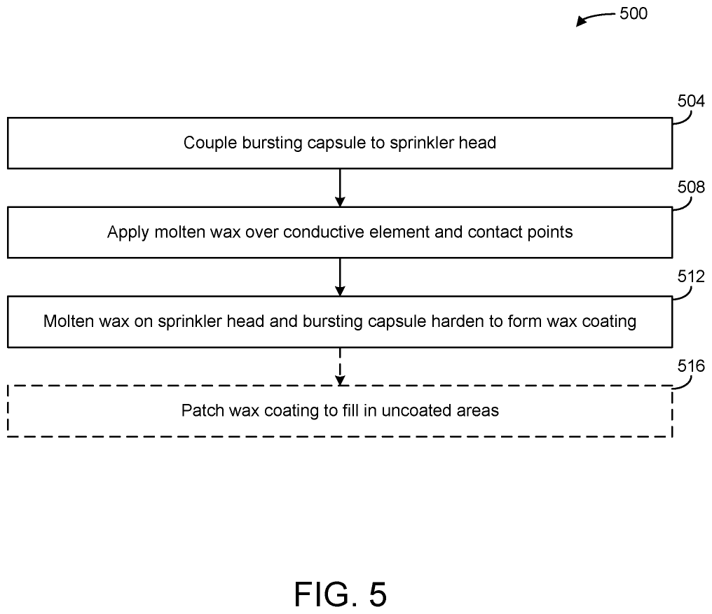

FIG. 5 illustrates another method 500 for manufacturing a sprinkler head 10 according to some embodiments. In step 504, the bursting capsule 14 is coupled to the sprinkler head 10 such that the electrically conductive element 34 of the bursting capsule 14 forms an electrical connection with the contact points 66, 70 in the sprinkler head 10.

In step 508, molten wax is applied over the electrically conductive element 34 and the contact points 66, 70. In some embodiments, the molten wax is poured over the electrically conductive element 34 and the contact points 66, 70. In other embodiments, a current is applied to the electrically conductive element 34 to increase a temperature of the electrically conductive element 34 to a temperature that is above the melting point of the molten wax but below a trigger temperature of the bursting capsule 14. Solid wax is then held over the electrically conductive element 34 and the contact points 66, 70 such that the solid wax melts over the electrically conductive element 34 and the contact points 66, 70.

In step 512, the molten wax on the bursting capsule 14 and the sprinkler head 10 (e.g., at least the contact points 66, 70) hardens, forming the wax coating 38. In some embodiments, the wax coating 38 can overlie only the electrically conductive element 34 and optionally a portion of the exterior surface of the wall 26 that is proximate the electrically conductive element 34. The wax coating 38 substantially covers the electrically conductive element 34, forming a contiguous coating on the electrically conductive element 34 and the contact points 66, 70. In some embodiments, the wax coating 38 can overlie only the electrically conductive element 34 and optionally a portion of the exterior surface of the wall 26 that is proximate the electrically conductive element 34. In some embodiments, the wax coating 38 completely encapsulates the electrically conductive element 34 and the contact points 66, 70.

In optional step 516, the wax coating 38 may be patched to fill in any uncoated areas.

Although the method 500 is described with respect to the sprinkler head 10 and the bursting capsule 14, it is contemplated that the method 500 can be used with the sprinkler head 110 and the bursting capsule 114 and the sprinkler head 210 and the bursting capsule 214 in a similar manner.

### Corrosion Resistance

The sprinkler head 10 and the bursting capsule 14 can be used in automatic sprinkler systems for fire protection systems. Accordingly, the sprinkler head 10 and the bursting capsule 14 must meet the Underwriters Laboratories (“UL”) 199 Standard. The thickness T of the wax coating 38 is sized so that the bursting capsule 14 can withstand an exposure to a 20% salt spray, hydrogen sulfide, and/or carbon dioxide-sulfur dioxide atmospheres over ten day testing periods. More specifically, the thickness T is configured to protect the electrically conductive element 34 from corrosion during the UL 199 10-day corrosion test conditions. For example, the electrical resistance and/or the electrical actuation response time of the bursting capsule 14 is not increased by more than a factor of 1.3, two, five, or ten after exposure to a moist hydrogen sulfide-air mixture pursuant to UL 199 10-day corrosion test conditions. The electrical resistance and/or the electrical actuation response time of the bursting capsule 14 is not increased by more than a factor of 1.3, two, five, or ten after exposure to 20% salt spray pursuant to UL 199 10-day corrosion test conditions. The electrical resistance and/or the electrical actuation response time of the bursting capsule 14 is not increased by more than a factor of 1.3, two, five, or ten after exposure to a carbon dioxide-sulfur dioxide atmosphere pursuant to UL 199 10-day corrosion test conditions.

As discussed above, the bursting capsule 14 has a predetermined response time at a predetermined trigger temperature. After exposure to a moist hydrogen sulfide-air mixture pursuant to UL 199 10-day corrosion test conditions, the bursting capsule 14 has a response time at the predetermined trigger temperature which is not greater than about 1.3, two, five, or ten times the predetermined response time. After exposure to 20% salt spray pursuant to UL 199 10-day corrosion test conditions, the bursting capsule 14 has a response time at the predetermined trigger temperature which is not greater than about 1.3, two, five, or ten times the predetermined response time. After exposure to a carbon dioxide-sulfur dioxide atmosphere pursuant to UL 199 10-day corrosion test conditions, the bursting capsule 14 has a response time at the predetermined trigger temperature which is not greater than about 1.3, two, five, or ten times the predetermined response time.

Table I summarizes the results of an exemplary corrosion test. In the exemplary corrosion test, two samples of bursting capsules 14 were coupled to sprinkler heads 10. The first sample included ten uncoated bursting capsules coupled to uncoated sprinkler heads. The second sample included four bursting capsules coupled to sprinkler heads that were coated with a paraffin wax using the method 400. The initial resistance of the electrically conductive element for each sample is illustrated below in Table 1. The two samples were then subjected to a moist hydrogen sulfide-air mixture pursuant to the UL 199 10-day corrosion test. At the end of the 10 day test period, the final resistances of the electrically conductive elements were measured for each of the bursting capsules in each sample. The average final resistance of the electrically conductive elements of the bursting capsules for each sample is illustrated below in Table 1.

TABLE 1
UL 199 10 Day Moist Hydrogen Sulfide Corrosion Test Results

| | | Initial | Final | |
|---|---|---|---|---|
| Sample | Coating | Resistance | Resistance | |
| 1 | Uncoated | 3.3 Ω | 1.2 × 10⁶ | Ω |
| 2 | Wax Coating | 3.3 Ω | 3.4 | Ω |

### Illustrative Embodiment

Reference is made in the following to a number of illustrative embodiments of the subject matter described herein. The following paragraphs describe illustrative embodiments that may include various features, characteristics, and advantages of the subject matter as presently described. Accordingly, the following embodiments should not be considered as being comprehensive of all of the possible embodiments or otherwise limit the scope of the methods, materials and compositions described herein.

An exemplary bursting capsule includes a hollow cavity completely enclosed and delimited by a vessel wall comprising a frangible material, a rupturing liquid disposed in the hollow cavity, an electrically conductive element disposed on an outside surface of the vessel wall, and a wax coating on at least a portion of the outside surface covering the electrically conductive element.

In some embodiments, the wax coating of the bursting capsule of paragraph [0064] is configured to melt at a predetermined melt temperature in the range of about 50 to 150° C. and often about 55 to 125° C.

In some embodiments, the bursting capsule of paragraphs [0064] or [0065] is a glass bulb.

In some embodiments, the wax coating of the bursting capsule of any of paragraphs [0068]-[0070] includes one or more of petroleum wax, mineral wax, animal wax and vegetable wax.

In some embodiments, the wax coating of the bursting capsule of paragraph [0071] includes petroleum wax, which includes paraffin wax and/or polyethylene wax.

In some embodiments, the wax coating of the bursting capsule of paragraph [0068] is formed from a wax having a melting point of about 50 to 100° C.

In some embodiments, the bursting capsule of any of paragraphs [0068]-[0073] has a predetermined trigger temperature in a range from 55 to 275° C.

In some embodiments, the bursting capsule of any of paragraphs [0068]-[0074] has an electrical actuation response time of no more than about 10 seconds.

In some embodiments, the electrically conductive element of the bursting capsule of any of paragraphs [0068]-[0075] has an electrical resistance of no more than about 10 ohms.

In some embodiments, the electrically conductive element of the bursting capsule of any of paragraphs [0068]-[0077] has an electrical resistance, which is increased by no more than a ten (10) multiple after exposure to a moist hydrogen sulfide-air mixture pursuant to UL 199 10-day corrosion test conditions.

In some embodiments, the bursting capsule of any of paragraphs [0068]-[0077] has an initial predetermined response time at a predetermined trigger temperature; and after exposure to a moist hydrogen sulfide-air mixture pursuant to UL 199 10-day corrosion test conditions, the bursting capsule has a response time at the predetermined trigger temperature which is not greater than about two (2) times the initial predetermined response time.

In some embodiments, the bursting capsule of any of paragraphs [0068]-[0078] has an initial electrical actuation response time; and after exposure to a moist hydrogen sulfide-air mixture pursuant to UL 199 10-day corrosion test conditions, the bursting capsule has an electrical actuation response time which is not greater than about two (2) times the initial electrical actuation response.

In some embodiments, the rupturing liquid of the bursting capsule of any of paragraphs [0068]-[0079] is configured to rupture the vessel wall after the bursting capsule has been at the predetermined trigger temperature for a predetermined response time of no more than about 210 seconds, often no more than about 180 seconds, in some instances no more than about 140 seconds, or even no more than about 30 seconds.

In some embodiments, the wax coating of the bursting capsule of any of paragraphs [0068]-[0080] covers substantially the entire outside surface of the vessel wall.

In some embodiments, the bursting capsule of any of paragraphs [0068]-[0081] includes the rupturing liquid and a gas bubble disposed in the hollow cavity. The frangible material includes glass. The electrically conductive element has an electrical resistance of no more than about 10 ohms. The bursting capsule has a predetermined trigger temperature in a range from 50 to 275° C. and an electrical actuation response time of no more than about 2 seconds. The wax coating is formed from a petroleum wax having a melting point of about 50 to 85° C. (circa 122° F. to 185° F.).

In some embodiments, the wax coating of the bursting capsule of paragraph [0082] is formed from a petroleum wax having a melting point of about 55 to 85° C. (circa 125° F. to 185° F.).

In some embodiments, a fire protection device comprising the bursting capsule of any of paragraphs [0068]-[0083].

In some embodiments, a fire protection system includes at least one fire protection sprinkler head, which includes the bursting capsule of any of paragraphs [0068]-[0083].

An exemplary fire protection device includes a fire protection sprinkler head that includes first and second electrical contact points in electrical contact with an electrically conductive element disposed on an outside surface of a vessel wall of a bursting capsule and a contiguous wax coating completely encapsulating the electrically conductive element and the first and second electrical contact points. The bursting capsule includes a hollow cavity completely enclosed and delimited by the vessel wall and a rupturing liquid disposed in the hollow cavity. The vessel wall includes a frangible material.

In some embodiments, the wax coating of the fire protection device of paragraph [0068] covers substantially the entire outside surface of the vessel wall.

An exemplary method for manufacturing a fire protection sprinkler head includes coupling a bursting capsule to a sprinkler head, which includes a first electrical contact point and a second electrical contact point, such that an electrical connection is formed between the first and second electrical contact points and an electrically conductive element disposed on an outside surface of a vessel wall of the bursting capsule. The method includes applying wax to at least a portion of the fire protection sprinkler head and the bursting capsule to form a contiguous wax coating completely encapsulating at least the electrically conductive element and the first and second electrical contact points.

In some embodiments, applying the wax as described in the method of paragraph [0088] includes dipping the bursting capsule coupled to the fire protection sprinkler head in a bath of molten wax having a melting point in the range of about 50 to 100° C. (circa 122° F. to 210° F.).

In some embodiments, wherein applying the wax as described in the method of paragraph [0088] comprises passing a current through the electrically conductive element and contacting a solid source of the wax with the electrically conductive element.

In some embodiments, in the method of paragraph [0090], the bursting capsule has a predetermined trigger temperature in a range from 55 to 275° C. and the wax has a melting point which is at least about 5° C. (9° F.) lower than the predetermined trigger temperature.

In some embodiments, in the method of any of paragraphs [0088]-[0091], the wax coating has an average thickness of at least about 250 μm.

An exemplary fire protection device includes a fire protection sprinkler head, which includes first and second electrical contact points in electrical contact with an electrically conductive element disposed on an outside surface of a vessel wall of a bursting capsule, and a contiguous wax coating completely encapsulating the electrically conductive element and the first and second electrical contact points. The bursting capsule includes a hollow cavity completely enclosed and delimited by the vessel wall and a rupturing liquid having a predetermined trigger temperature disposed in the hollow cavity. The vessel wall includes a frangible material.

In some embodiments, the electrically conductive element of the fire protection device of paragraph [0093] has an electrical resistance, which is increased by no more than a ten (10) multiple after exposure to a moist hydrogen sulfide-air mixture pursuant to UL 199 10-day corrosion test conditions.

In some embodiments, the bursting capsule of the fire protection device of any of paragraphs [0093] and [0094] has an initial predetermined response time at the predetermined trigger temperature; and after exposure to a moist hydrogen sulfide-air mixture pursuant to UL 199 10-day corrosion test conditions, the bursting capsule has a response time at the predetermined trigger temperature which is not greater than about two (2) times the initial predetermined response time.

In some embodiments, the bursting capsule of the fire protection device of any of paragraphs [0093]-[0095] has an initial electrical actuation response time. After exposure to a moist hydrogen sulfide-air mixture pursuant to UL 199 10-day corrosion test conditions, the bursting capsule has an electrical actuation response time which is not greater than about two (2) times the initial electrical actuation response time.

In some embodiments, the rupturing liquid of the fire protection device of any of paragraphs [0093]-[0096] is configured to rupture the vessel wall after the bursting capsule has been at the predetermined trigger temperature for a predetermined response time of no more than about 210 seconds, often no more than about 180 seconds, in some instances no more than about 140 seconds, or even no more than about 30 seconds.

In some embodiments, the predetermined trigger temperature of the bursting capsule of the fire protection device of any of paragraphs [0093]-[0097] is about 57° C. (135° F.) and the contiguous wax coating is a petroleum wax that has a melting point of about 50° C. (122° F.) to about 54° C. (129° F.).

In some embodiments, the predetermined trigger temperature of the bursting capsule of the fire protection device of any of paragraphs [0093]-[0097] is about 68° C. (155° F.) and the contiguous wax coating is a petroleum wax that has a melting point of about 54° C. (129° F.) to about 58° C. (137° F.).

In some embodiments, the predetermined trigger temperature of the bursting capsule of the fire protection device of any of paragraphs [0093]-[0097] is about 79° C. (175° F.) and the contiguous wax coating is a petroleum wax that has a melting point of about 71° C. (160° F.) to about 75° C. (167° F.).

In some embodiments, the predetermined trigger temperature of the bursting capsule of the fire protection device of any of paragraphs [0093]-[0097] is about 93° C. (200° F.) or about 141° C. (286° F.) and the contiguous wax coating is a petroleum wax that has a melting point of about 77° C. (170° F.) to about 81° C. (178° F.).

In some embodiments, the predetermined trigger temperature of the bursting capsule of the fire protection device of any of paragraphs [0093]-[0097] is about 74° C. (165° F.) and the contiguous wax coating is a mineral wax that has a melting point of about 61° C. (142° F.).

In some embodiments, the predetermined trigger temperature of the bursting capsule of the fire protection device of any of paragraphs [0093]-[0097] is about 100° C. (212° F.) or about 141° C. (286° F.) and the contiguous wax coating is a mineral wax that has a melting point of about 79° C. (175° F.) and a congealing point of about 73° C. (164° F.).

An exemplary fire protection sprinkler head includes a body, a heat-responsive trigger, and a closure assembly. The body defines an internal passageway with an outlet end. The heat-responsive trigger is mounted to releasably secure a closure element at the outlet end. The heat-responsive trigger includes an electrically conductive element configured to actuate the heat-responsive trigger. The closure assembly includes the closure element mounted in a manner to secure the outlet end of the internal passageway against a flow of fire-fighting fluid in a non-fire condition and to release a flow of the fire-fighting fluid from the outlet end of the internal passageway in response to passage of a current through the electrically conductive element. The heat-responsive trigger comprises a contiguous wax coating covering the electrically conductive element and first and second electrical contact points, which are in electrical contact with and configured to deliver an electric current through the electrically conductive element.

In some embodiments, the trigger of the fire protection sprinkler head of paragraph [0104] is a liquid-filled glass bulb having the electrically conductive element disposed on an outer wall.

In some embodiments, the liquid-filled glass bulb of the fire protection sprinkler head of paragraph [0105] includes a rupturing liquid and a gas bubble disposed in a hollow cavity; and the electrically conductive element has an electrical resistance of no more than about 10 ohms.

In some embodiments, the heat-responsive trigger of the fire protection sprinkler head of any of paragraphs [0104]-[0106] has a predetermined trigger temperature in a range from 50 to 275° C. and an electrical actuation response time of no more than about 10 seconds and, often, no more than about 5 seconds.

In some embodiments, the electrically conductive element of the fire protection sprinkler head of any of paragraphs [0104]-[0107] has an electrical resistance, which is increased by no more than a ten (10) multiple after exposure to a moist hydrogen sulfide-air mixture pursuant to UL 199 10-day corrosion test conditions.

In some embodiments, the bursting capsule of the fire protection sprinkler head of any of paragraphs [0104]-[0108] has an initial predetermined response time at the predetermined trigger temperature. After exposure to a moist hydrogen sulfide-air mixture pursuant to UL 199 10-day corrosion test conditions, the bursting capsule has a response time at the predetermined trigger temperature which is not greater than about two (2) times the initial predetermined response time.

In some embodiments, the electrically conductive element of the fire protection sprinkler head of any of paragraphs [0104]-[0109] has an initial electrical actuation response time. After exposure to a moist hydrogen sulfide-air mixture pursuant to UL 199 10-day corrosion test conditions, the bursting capsule has an electrical actuation response time which is not greater than about two (2) times the initial electrical actuation response time.

In some embodiments, the electrical actuation response time of the fire protection sprinkler head of any of paragraphs [0104]-[0110] is no more than about 210 seconds, often no more than about 180 seconds, in some instances no more than about 140 seconds, or even no more than about 30 seconds.

In some embodiments, the predetermined trigger temperature of the bursting capsule of the fire protection sprinkler head of any of paragraphs [0104]-[0111] is about 57° C. (135° F.) and the contiguous wax coating is a petroleum wax that has a melting point of about 50° C. (122° F.) to about 54° C. (129° F.).

In some embodiments, the predetermined trigger temperature of the bursting capsule of the fire protection sprinkler head of any of paragraphs [0104]-[0111] is about 68° C. (155° F.) and the contiguous wax coating is a petroleum wax that has a melting point of about 54° C. (130° F.) to about 58° C. (137° F.).

In some embodiments, the predetermined trigger temperature of the bursting capsule of the fire protection sprinkler head of any of paragraphs [0104]-[0111] is about 79.4° C. (175° F.) and the contiguous wax coating is a petroleum wax that has a melting point of about 71.1° C. (160° F.) to about 75° C. (167° F.).

In some embodiments, the predetermined trigger temperature of the bursting capsule of the fire protection sprinkler head of any of paragraphs [0104]-[0111] is about 93° C. (200° F.) or about 141° C. (286° F.) and the contiguous wax coating is a petroleum wax that has a melting point of about 77° C. (170° F.) to about 81° C. (177° F.).

In some embodiments, the predetermined trigger temperature of the bursting capsule of the fire protection sprinkler head of any of paragraphs [0104]-[0111] is about 74° C. (165° F.) and the contiguous wax coating is a mineral wax that has a melting point of about 61° C. (142° F.).

In some embodiments, the predetermined trigger temperature of the bursting capsule of the fire protection sprinkler head of any of paragraphs [0104]-[0111] is about 100° C. (212° F.) or about 141° C. (286° F.) and the contiguous wax coating is a mineral wax that has a melting point of about 79° C. (175° F.) and a congealing point of about 73° C. (164° F.).

In some embodiments, a fire protection system includes one or more of the fire protection sprinkler heads according to any of paragraphs [0104]-[0117].

In some embodiments, the bursting capsule of any of paragraphs [0068] to [0072] has a predetermined trigger temperature of about 57° C. (135° F.) to about 141° C. (286° F.) and the wax coating has a melting point of about 50° C. (122° F.) to about 81° C. (177° F.).

In some embodiments, the wax coating of the bursting capsule of any of paragraphs [0068] to [0075] and [0112] to [0117] has a melting point which is at least about 5° C. (9° F.) lower than the predetermined trigger temperature.

In some embodiments, the rupturing liquid of the bursting capsule of any of paragraphs [0068] to [0075] and [0112] to [0117] is configured to rupture the vessel wall after the bursting capsule has been at the predetermined trigger temperature for a predetermined response time of no more than about 10 seconds.

In some embodiments, the predetermined trigger temperature of the bursting capsule of any of paragraphs [0068] to [0075] and [0112] to [0117] is about 57° C. (135° F.) and the wax coating is a petroleum wax that has a melting point of about 50° C. (122° F.) to about 54° C. (129° F.).

In some embodiments, the predetermined trigger temperature of the bursting capsule of any of paragraphs [0068] to [0075] and [0112] to [0117] is about 68° C. (155° F.) and the wax coating is a petroleum wax that has a melting point of about 54° C. (130° F.) to about 58° C. (137° F.).

In some embodiments, the predetermined trigger temperature of the bursting capsule of any of paragraphs [0068] to [0075] and [0112] to [0117] is about 79° C. (175° F.) and the wax coating is a petroleum wax that has a melting point of about 71° C. (160° F.) to about 75° C. (167° F.).

In some embodiments, the predetermined trigger temperature of the bursting capsule of any of paragraphs [0068] to [0075] and [0112] to [0117] is about 93° C. (200° F.) or about 141° C. (286° F.) and the wax coating is a petroleum wax that has a melting point of about 77° C. (170° F.) to about 81° C. (177° F.).

In some embodiments, the predetermined trigger temperature of the bursting capsule of any of paragraphs [0068] to [0075] and [0112] to [0117]is about 74° C. (165° F.) and the wax coating is a mineral wax that has a melting point of about 61° C. (142° F.).

In some embodiments, the predetermined trigger temperature of the bursting capsule of any of paragraphs [0068] to [0075] and [0112] to [0117] is about 100° C. (212° F.) or about 141° C. (286° F.) and the wax coating is a mineral wax that has a melting point of about 79° C. (175° F.) and a congealing point of about 73° C. (164° F.).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

Those skilled in the art will appreciate that the description herein is illustrative only and is not intended to be in any way limiting. Other aspects, inventive features, and advantages of the devices and/or processes described herein will become apparent from the description set forth herein and taken in conjunction with the accompanying drawings.

1. A bursting capsule comprising
a hollow cavity completely enclosed and delimited by a vessel wall comprising a frangible material;
a rupturing liquid disposed in the hollow cavity;
an electrically conductive element disposed on an outside surface of the vessel wall; and
a wax coating on at least a portion of the outside surface covering the electrically conductive element.

2-3. (canceled)

4. The bursting capsule of claim 1, wherein the wax coating comprises one or more of petroleum wax, mineral wax, animal wax and vegetable wax.

5-8. (canceled)

9. The bursting capsule of claim 1, wherein the wax coating covers substantially the entire outside surface of the vessel wall.

10. (canceled)

11. The bursting capsule of claim 1, wherein the wax coating has an average thickness of at least about 250 pm.

12-19. (canceled)

20. The bursting capsule of claim 1, comprising the rupturing liquid and a gas bubble disposed in the hollow cavity;
wherein the frangible material comprises glass; the electrically conductive element has an electrical resistance of no more than about 10 ohms;
the bursting capsule has a predetermined trigger temperature in a range from 50 to 275° C. and an electrical actuation response time of no more than about 10 seconds; and
the wax coating is formed from a wax having a melting point of about 50 to 85° C.

21. A fire protection sprinkler head comprising the bursting capsule of claim 1.

22. A fire protection sprinkler head comprising:
a body defining an internal passageway with an outlet end;
a heat-responsive trigger mounted to releasably secure a closure element at the outlet end, the heat-responsive trigger including an electrically conductive element configured to actuate the heat-responsive trigger; and
a closure assembly comprising the closure element mounted in a manner to secure the outlet end of the internal passageway against a flow of fire-fighting fluid in a non-fire condition and to release a flow of the fire-fighting fluid from the outlet end of the internal passageway in response to passage of a current through the electrically conductive element;
wherein the heat-responsive trigger comprises a contiguous wax coating covering the electrically conductive element and first and second electrical contact points, which are in electrical contact with and configured to deliver an electric current through the electrically conductive element.

23. (canceled)

24. The fire protection sprinkler head of claim 22, wherein the heat-responsive trigger is a liquid-filled glass bulb having the electrically conductive element disposed on an outer wall;
the liquid-filled glass bulb comprises a rupturing liquid and a gas bubble disposed in a hollow cavity;
the contiguous wax coating substantially covers an entire outside surface of the liquid-filled glass bulb; and
the electrically conductive element has an electrical resistance of no more than about 10 ohms.

25. The fire protection sprinkler head claim 24, wherein the electrically conductive element has an electrical resistance, which is increased by no more than a ten (10) multiple after exposure to a moist hydrogen sulfide-air mixture pursuant to UL 199 10-day corrosion test conditions.

26. The fire protection sprinkler head of claim 24, wherein the bursting capsule has an initial electrical actuation response time; and
after exposure to a moist hydrogen sulfide-air mixture pursuant to UL 199 10-day corrosion test conditions, the bursting capsule has an electrical actuation response time which is not greater than about two (2) times the initial electrical actuation response time.

27. The fire protection sprinkler head of claim 24, wherein the heat-responsive trigger has a predetermined trigger temperature in a range from 50 to 275° C. and an electrical actuation response time of no more than about 10 seconds.

28. A fire protection system comprising one or more of the fire protection sprinkler heads according to claim 24.

29. A fire protection device comprising a sprinkler head, which comprises first and second electrical contact points in electrical contact with an electrically conductive element disposed on an outside surface of a vessel wall of a bursting capsule; and
a contiguous wax coating completely encapsulating the electrically conductive element and the first and second electrical contact points; and
wherein the bursting capsule comprises a hollow cavity completely enclosed and delimited by the vessel wall, which comprises a frangible material, and a rupturing liquid disposed in the hollow cavity.

30. The fire protection device of claim 29, wherein the wax coating substantially covers the entire outside surface of the vessel wall.

31. A method for manufacturing a sprinkler head comprising:
coupling a bursting capsule to a sprinkler head, which includes a first electrical contact point and a second electrical contact point, such that an electrical connection is formed between the first and second electrical contact points and an electrically conductive element disposed on an outside surface of a vessel wall of the bursting capsule; and
applying wax to at least a portion of the sprinkler head and the bursting capsule to form a contiguous wax coating completely encapsulating at least the electrically conductive element and the first and second electrical contact points.

32. The method of claim 31, wherein applying the wax comprises dipping the bursting capsule coupled to the sprinkler head in a bath of molten wax.

33. The method of claim 31, wherein applying the wax comprises passing a current through the electrically conductive element and contacting a solid source of the wax with the electrically conductive element.

34. The fire protection device of claim 29, wherein the wax coating has an average thickness of at least about 250 pm.

35. The fire protection device of claim 29, wherein the bursting capsule has an electrical actuation response time of no more than about 10 seconds.

36. The fire protection device of claim 29, wherein the contiguous wax coating is formed from a wax having a melting point of about 50 to 100° C.
